(19) United States
(12) Patent Application Publication
(10) Pub. No.: US 2026/0022439 A1
(43) Pub. Date: Jan. 22, 2026

(54) COPPER ALLOY FOR SLIDING MEMBERS, SLIDING MEMBER, AND METHOD FOR PRODUCING COPPER ALLOY FOR SLIDING MEMBERS

(71) Applicant: KOMATSU LTD., Tokyo (JP)

(72) Inventors: Yoshikiyo TANAKA, Otsu-shi (JP); Ryoichiro HAYASHI, Otsu-shi (JP); Tsubasa HIGUCHI, Tokyo (JP); Akihiro OCHIAI, Tokyo (JP)

(73) Assignee: KOMATSU LTD., Tokyo (JP)

(21) Appl. No.: 18/997,944

(22) PCT Filed: Aug. 2, 2023
(86) PCT No.: PCT/JP2023/028301

§ 371 Date: Jan. 23, 2025

(30) Foreign Application Priority Data
Aug. 8, 2022 (JP) 2022-126624

(51) Int. Cl. C22C 9/02; B22F 3/12; C22C 1/04; C22C 1/059; F16C 33/12

(52) U.S. Cl. CPC C22C 9/02; B22F 3/12; C22C 1/0425; C22C 1/059; F16C 33/121; B22F 2301/10; F16C 2204/12

(57) ABSTRACT

A copper alloy for sliding members constituting a sliding layer has a component composition containing not less than 0.4 mass % and not more than 6 mass % Mn, not less than 0.3 mass % and not more than 5 mass % Fe, not less than 0.3 mass % and not more than 3.5 mass % S, and not less than 1 mass % and not more than 15 mass % Sn, with the balance being Cu and unavoidable impurities. The copper alloy for sliding members has a structure including a matrix made of bronze and a complex sulfide phase dispersed in the matrix, the complex sulfide phase containing not less than 40 atom % and not more than 75 atom % Mn, not less than 3 atom % and not more than 30 atom % Fe, and not less than 1 atom % and not more than 55 atom % S.

### TECHNICAL FIELD

The present disclosure relates to a copper alloy for sliding members, a sliding member, and a method of producing a copper alloy for sliding members.

The present application claims priority based on Japanese Patent Application No. 2022-126624 filed on Aug. 8, 2022, the entire contents of which are incorporated herein by reference.

### BACKGROUND ART

In a sliding member including a sliding surface which comes into contact with and slides against another member, a copper alloy for sliding members may be used as a material constituting at least a region including the sliding surface. As the copper alloys for sliding members, copper alloys containing Pb (lead) are known. On the other hand, from the viewpoint of reducing environmental load, a copper alloy for sliding members that contains Cu₅FeS₄, avoiding the addition of Pb, has been proposed (see, for example, International Publication WO 2011/132703 (Patent Literature 1)).

### CITATION LIST

### Patent Literature

Patent Literature 1: International Publication WO 2011/132703

### SUMMARY OF INVENTION

### Technical Problem

As described above, there is a demand for a copper alloy for sliding members which avoids the addition of Pb from the viewpoint of reducing environmental load. One of the objects of the present disclosure is to provide a copper alloy for sliding members having excellent wear resistance while avoiding the addition of Pb, and a sliding member having excellent sliding properties by including the copper alloy for sliding members.

### Solution to Problem

A copper alloy for sliding members of the present disclosure has a component composition containing not less than 0.4 mass % and not more than 6 mass % Mn (manganese), not less than 0.3 mass % and not more than 5 mass % Fe (iron), not less than 0.3 mass % and not more than 3.5 mass % S (sulfur), and not less than 1 mass % and not more than 15 mass % Sn (tin), with the balance being Cu (copper) and unavoidable impurities. The copper alloy for sliding members of the present disclosure has a structure including a matrix made of bronze and a complex sulfide phase dispersed in the matrix, the complex sulfide phase containing not less than 40 atom % and not more than 75 atom % Mn, not less than 3 atom % and not more than 30 atom % Fe, and not less than 1 atom % and not more than 55 atom % S.

A method of producing a copper alloy for sliding members of the present disclosure includes a step of preparing mixed powder, a step of fabricating a formed body, and a step of forming a structure. In the step of preparing mixed powder, Cu powder, Cu alloy powder containing not less than 10 mass % and not more than 40 mass % Sn, at least one of FeS powder and CuS powder, and at least one selected from the group consisting of Cu alloy powder containing not less than 5 mass % Mn, Fe—Mn alloy powder containing not less than 60 mass % Mn, and Mn powder, are mixed so as to achieve a component composition containing not less than 0.4 mass % and not more than 6 mass % Mn, not less than 0.3 mass % and not more than 5 mass % Fe, not less than 0.3 mass % and not more than 3.5 mass % S, and not less than 1 mass % and not more than 15 mass % Sn, with the balance being Cu and unavoidable impurities, to thereby prepare mixed powder. In the step of fabricating a formed body, the mixed powder is compacted to fabricate a formed body. In the step of forming a structure, the formed body is heated to thereby form a structure including a matrix made of bronze and a complex sulfide phase dispersed in the matrix, the complex sulfide phase containing not less than 40 atom % and not more than 75 atom % Mn, not less than 3 atom % and not more than 30 atom % Fe, and not less than 1 atom % and not more than 55 atom % S.

### Advantageous Effects of Invention

According to the above-described copper alloy for sliding members and method of producing the same, it is possible to provide a copper alloy for sliding members having excellent wear resistance while avoiding the addition of Pb.

### BRIEF DESCRIPTION OF DRAWINGS

FIG. 1 is a schematic perspective view showing the appearance of a hydraulic excavator.

FIG. 2 is a schematic plan view showing the structure of a track travel device included in the hydraulic excavator.

FIG. 3 is an exploded view showing the structure of a track roller including bushings.

FIG. 4 is a schematic cross-sectional view showing the structure of a bushing.

FIG. 5 is an optical micrograph showing the state of the metallographic structure of a copper alloy for sliding members.

FIG. 6 is a flowchart illustrating the outline of a method of producing a copper alloy for sliding members.

FIG. 7 is a schematic diagram illustrating a method of wear resistance test.

FIG. 8 is a diagram showing a relationship between the volume proportion of a complex sulfide phase and the wear resistance in each sample.

### DESCRIPTION OF EMBODIMENTS

### Outline of Embodiments

A copper alloy for sliding members according to the present disclosure has a component composition containing not less than 0.4 mass % and not more than 6 mass % Mn, not less than 0.3 mass % and not more than 5 mass % Fe, not less than 0.3 mass % and not more than 3.5 mass % S, and not less than 1 mass % and not more than 15 mass % Sn, with the balance being Cu and unavoidable impurities. The copper alloy for sliding members of the present disclosure has a structure including a matrix made of bronze and a complex sulfide phase dispersed in the matrix, the complex sulfide phase containing not less than 40 atom % and not more than 75 atom % Mn, not less than 3 atom % and not more than 30 atom % Fe, and not less than 1 atom % and not more than 55 atom % S.

The present inventors have studied the compositions and structures of copper alloys for sliding members avoiding the addition of Pb, and have found that a copper alloy for sliding members having excellent wear resistance while avoiding the addition of Pb can be obtained by adopting a structure in which a Mn—Fe based complex sulfide phase is dispersed in a matrix made of bronze. Specifically, a copper alloy for sliding members having excellent wear resistance can be obtained by forming, in a Cu alloy having a component composition containing appropriate amounts of Mn, Fe, S, and Sn, a structure in which a Mn—Fe based complex sulfide phase (hereinafter, sometimes simply referred to as “complex sulfide phase”) having a certain atomic ratio is dispersed in a matrix made of bronze.

The reasons for limiting the component composition of the copper alloy for sliding members of the present disclosure to the above-described ranges will now be described.

Mn: Not Less than 0.4 Mass % and not More than 6 Mass %

Mn is an element necessary for the formation of a Mn—Fe based complex sulfide phase. If the Mn content is less than 0.4 mass %, it is difficult to properly form the Mn—Fe based complex sulfide phase. On the other hand, if the Mn content exceeds 6 mass %, the total amount of sulfides formed will increase and the structure will become brittle. In the case where the copper alloy for sliding members is produced by using a powder sintering method, there may occur a sweating phenomenon (a phenomenon in which a liquid phase seeps out onto the surface during the production of the copper alloy for sliding members by sintering). Therefore, it is necessary to set the Mn content within the above range. From the viewpoint of facilitating the formation of a sufficient amount of Mn—Fe based complex sulfide phase, the Mn content is preferably set to 0.5 mass % or more. On the other hand, from the viewpoint of more reliably preventing embrittlement of the structure, the Mn content is preferably set to 5 mass % or less.

Fe: Not Less than 0.3 Mass % and not More than 5 Mass %

Fe is an element necessary for the formation of a Mn—Fe based complex sulfide phase. If the Fe content is less than 0.3 mass %, it is difficult to form the Mn—Fe based complex sulfide phase in an amount necessary to ensure sufficient sliding properties. On the other hand, if the Fe content exceeds 5 mass %, the proportion of Fe dissolved in a solid state in the Cu alloy will increase. This results in increased hardness of the Cu alloy. If such a Cu alloy is used for a sliding member, the member may cause more damage to the other members and the sliding properties may be deteriorated. Therefore, it is necessary to set the Fe content within the above range. From the viewpoint of facilitating the formation of a sufficient Mn—Fe based complex sulfide phase, the Fe content is preferably set to 0.5 mass % or more.

S: Not Less than 0.3 Mass % and not More than 3.5 Mass %

S is an element necessary for the formation of a Mn—Fe based complex sulfide phase. If the S content is less than 0.3 mass %, it is difficult to properly form the Mn—Fe based complex sulfide phase. On the other hand, if the S content exceeds 3.5 mass %, in the case of producing the copper alloy for sliding members by using the powder sintering method, the amount of liquid phase generated will increase, causing the sintering to proceed excessively, so the original shape of the formed body may not be maintained. Therefore, it is necessary to set the S content within the above range. From the viewpoint of facilitating the proper formation of the Mn—Fe based complex sulfide phase, the S content is preferably set to 0.5 mass % or more. On the other hand, from the viewpoint of more reliably preventing a decrease in strength of the copper alloy, the S content is preferably set to 3.0 mass % or less.

Sn: Not Less than 1 Mass % and not More than 15 Mass %

Sn is an element that constitutes a matrix made of bronze. From the viewpoint of facilitating sintering by forming a liquid phase during the production according to sintering, the Sn content is necessary to be 1 mass % or more. On the other hand, if the Sn content exceeds 15 mass %, the strength of the copper alloy begins to decrease. Therefore, it is necessary to set the Sn content within the above range. From the viewpoint of further facilitating sintering, the Sn content is preferably set to 5 mass % or more. On the other hand, from the viewpoint of more reliably preventing a decrease in strength of the copper alloy, the Sn content is preferably set to 12 mass % or less.

### Unavoidable Impurities

In addition to the components intentionally added in the production process, elements other than those described above may be contained as unavoidable impurities in the copper alloy for sliding members. Phosphorus (P) as an unavoidable impurity combines with Fe to form phosphides, which hinders the formation of the Mn—Fe based complex sulfide phase and reduces the strength of the copper alloy. Therefore, the P content is preferably 0.03 mass % or less. In addition to P, other elements such as Al (aluminum) and Si (silicon) may be contained as unavoidable impurities in the copper alloy for sliding members. The contents of these elements are also preferably 0.1 mass % or less and 0.1 mass % or less, respectively. The total amount of unavoidable impurities is preferably 0.5 mass % or less.

According to the copper alloy for sliding members of the present disclosure, excellent wear resistance can be achieved while avoiding the addition of Pb by having, in the Cu alloy with the above-described appropriate component composition, a structure in which the Mn—Fe complex sulfide phase having a certain atomic ratio is dispersed in the matrix made of bronze.

In the above copper alloy for sliding members, the bronze constituting the matrix may have a single phase of a phase. With this configuration, high sliding properties can be achieved more reliably.

In the above copper alloy for sliding members, the proportion of the complex sulfide phase in the copper alloy for sliding members may be not less than 3 vol % and not more than 20 vol %. Setting the proportion of the complex sulfide phase to 3 vol % or more makes it possible to achieve high wear resistance more reliably. Setting the proportion of the complex sulfide phase to 20 vol % or less can suppress the phenomenon (sweating phenomenon) in which a liquid phase seeps out onto the surface during the production of the copper alloy for sliding members by sintering.

A sliding member of the present disclosure is a sliding member including a sliding surface which comes into contact with and slides against another member. The sliding member has at least a region including the sliding surface composed of the above-described copper alloy for sliding members of the present disclosure. According to the sliding member of the present disclosure, it is possible to provide a sliding member whose sliding surface is composed of a copper alloy for sliding members having excellent wear resistance while avoiding the addition of Pb.

A method of producing a copper alloy for sliding members according to the present disclosure includes a step of preparing mixed powder, a step of fabricating a formed body, and a step of forming a structure. In the step of preparing mixed powder, Cu powder, Cu alloy powder containing not less than 10 mass % and not more than 40 mass % Sn, at least one of FeS powder and CuS powder, and at least one selected from the group consisting of Cu alloy powder containing not less than 5 mass % Mn, Fe—Mn alloy powder containing not less than 60 mass % Mn, and Mn powder, are mixed so as to achieve a component composition containing not less than 0.4 mass % and not more than 6 mass % Mn, not less than 0.3 mass % and not more than 5 mass % Fe, not less than 0.3 mass % and not more than 3.5 mass % S, and not less than 1 mass % and not more than 15 mass % Sn, with the balance being Cu and unavoidable impurities, to thereby prepare mixed powder. In the step of fabricating a formed body, the mixed powder is compacted to fabricate a formed body. In the step of forming a structure, the formed body is heated to thereby form a structure including a matrix made of bronze and a complex sulfide phase dispersed in the matrix, the complex sulfide phase containing not less than 40 atom % and not more than 75 atom % Mn, not less than 3 atom % and not more than 30 atom % Fe, and not less than 1 atom % and not more than 55 atom % S.

According to the method of producing a copper alloy for sliding members of the present disclosure, the above-described copper alloy for sliding members of the present disclosure can be easily produced.

### Illustration of Specific Embodiments

Specific embodiments of the copper alloy for sliding members and the sliding member of the present disclosure will be described below with reference to the drawings. In the drawings referenced below, the same or corresponding portions are denoted by the same reference numerals and the description thereof will not be repeated.

Embodiments of the copper alloy for sliding members and the sliding member of the present disclosure will now be described by taking as an example the case in which the sliding member of the present disclosure is adopted as a bushing included in a track travel device of a hydraulic excavator, which is a work vehicle.

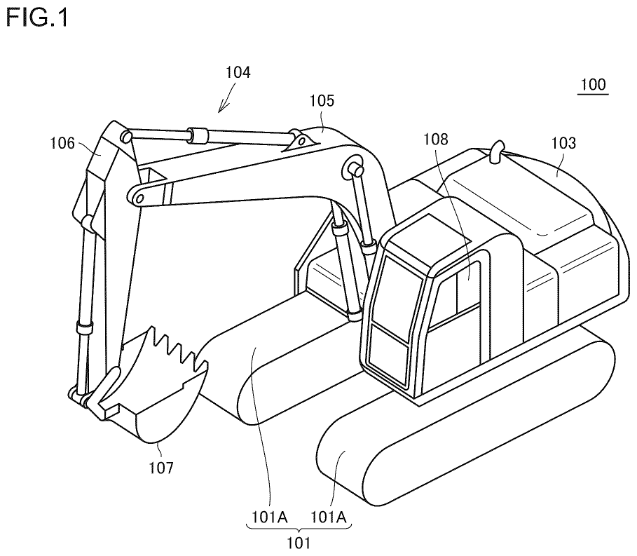

FIG. 1 is a schematic perspective view showing the appearance of a hydraulic excavator. Referring to FIG. 1, the hydraulic excavator 100 includes a track travel device 101, a revolving unit 103, and a work implement 104. The main body of the hydraulic excavator includes the track travel device 101 and the revolving unit 103. The track travel device 101 includes a pair of tracks 101A. The revolving unit 103 is attached to the track travel device 101 via a revolving mechanism at the top of the track travel device 101. The revolving unit 103 includes a cab 108.

The work implement 104 is supported operably in the vertical direction on the revolving unit 103 and can perform work such as excavating sand and other materials. The work implement 104 includes a boom 105, an arm 106, and a bucket 107. The boom 105 has its base portion connected to the revolving unit 103. The arm 106 is connected to a distal end of the boom 105. The bucket 107 is connected to a distal end of the arm 106. The boom 105, the arm 106, and the bucket 107 are each driven by a hydraulic cylinder, thereby allowing the work implement 104 to perform the desired operation.

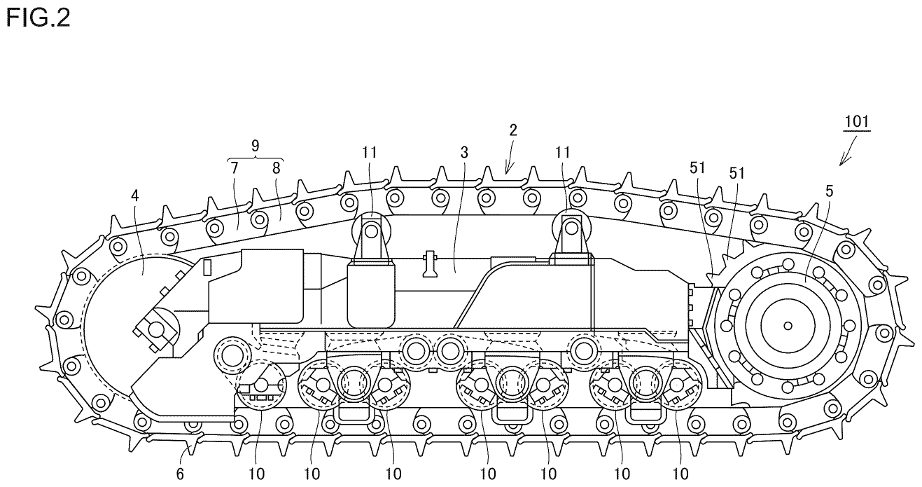

FIG. 2 is a schematic plan view showing the structure of the track travel device included in the hydraulic excavator. Referring to FIG. 2, the track travel device 101 includes a track 2, a track frame 3, an idler tumbler 4, a sprocket wheel 5, a plurality of (here, seven) track rollers 10, and a plurality of (here, two) carrier rollers 11.

The track 2 includes a plurality of track links 9 connected in an annular (endless) manner, and track shoes 6 fixed to the corresponding track links 9. The track links 9 include outer links 7 and inner links 8. The outer links 7 and the inner links 8 are connected alternately.

The idler tumbler 4, the plurality of (here, seven) track rollers 10, and the plurality of (here, two) carrier rollers 11 are attached to the track frame 3 so as to be rotatable about their respective axes. As viewed from the center of the track frame 3, the sprocket wheel 5 is disposed at an end of the track frame opposite to the end to which the idler tumbler 4 is attached. A power source such as an engine is connected to the sprocket wheel 5, and the sprocket wheel 5, driven by the power source, rotates about its axis. On an outer peripheral surface of the sprocket wheel 5, a plurality of sprocket teeth 51 are arranged, which are projections projecting radially outward. Each sprocket tooth 51 is engaged with the track 2, so the rotation of the sprocket wheel 5 is transmitted to the track 2. As a result, the track 2 rotates in a circumferential direction while being driven by the rotation of the sprocket wheel 5.

The idler tumbler 4 is attached to the end (opposite to the end at which the sprocket wheel 5 is disposed) of the track frame 3. In a region of the track frame 3 sandwiched between the sprocket wheel 5 and the idler tumbler 4, the track rollers 10 are attached to the ground contact side and the carrier rollers 11 are attached to the side opposite to the ground contact side. The idler tumbler 4, the track rollers 10, and the carrier rollers 11 have their outer peripheral surfaces in contact with an inner peripheral surface of the track 2. As a result, the track 2, driven by the rotation of the sprocket wheel 5, rotates in the circumferential direction while being guided by the idler tumbler 4, the sprocket wheel 5, the track rollers 10, and the carrier rollers 11.

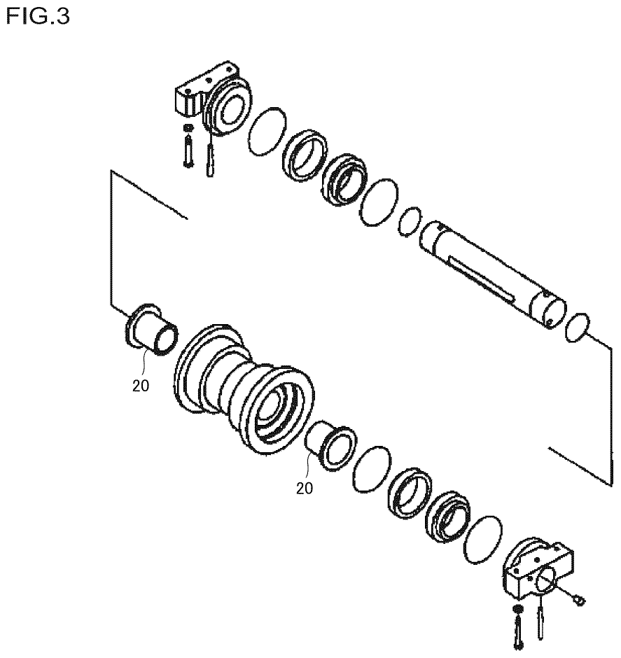

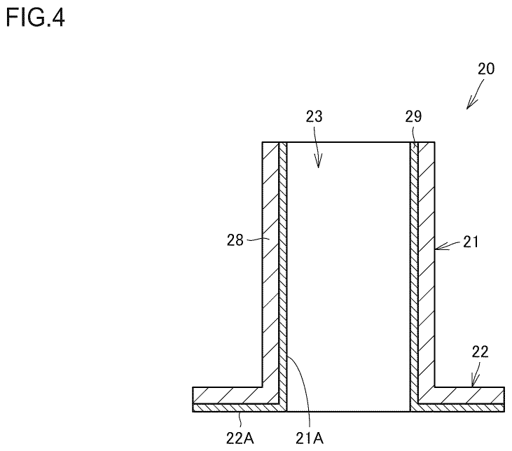

FIG. 3 is an exploded view showing the structure of a track roller including bushings. FIG. 4 is a schematic cross-sectional view showing the structure of a bushing. The track roller 10 has a structure including a pair of bushings 20, as shown in FIG. 3. Referring to FIGS. 3 and 4, the bushing 20 includes a main body 21 having a cylindrical shape, and a disk-shaped flange 22 connected to one end in an axial direction of the main body 21 and having a larger outside diameter than the main body 21. The main body 21 has a central axis coinciding with a central axis of the flange. The bushing 20 has a cylindrical through hole 23 formed to penetrate through the main body 21 and the flange 22 in the axial direction. The through hole 23 has a central axis coinciding with those of the main body 21 and the flange 22. The bushing 20 has a hollow cylindrical shape.

Referring to FIG. 4, the bushing 20 includes a base portion 28 made of steel, and a sliding layer 29 that covers a portion of a surface of the base portion 28. The sliding layer 29 is arranged to constitute an inner wall 21A surrounding the through hole 23 of the bushing 20, and an end surface 22A of the flange 22 on a side opposite to the main body 21. The inner wall 21A and the end surface 22A are sliding surfaces which come into contact with and slide against other members. While the steel constituting the base portion 28 is not particularly limited, it may be, for example, cold-rolled steel plate such as JIS standard SPHC, mild steel such as JIS standard SS400, carbon steel for machine structural use, alloy steel for machine structural use, or the like. The sliding layer 29 is composed of a copper alloy for sliding members. This copper alloy for sliding members contains not less than 0.4 mass % and not more than 6 mass % Mn, not less than 0.3 mass % and not more than 5 mass % Fe, not less than 0.3 mass % and not more than 3.5 mass % S, and not less than 1 mass % and not more than 15 mass % Sn, with the balance being Cu and unavoidable impurities.

FIG. 5 is an optical micrograph showing the state of the metallographic structure of a copper alloy for sliding members. Referring to FIG. 5, the copper alloy for sliding members constituting the sliding layer 29 includes a matrix 71 made of bronze, and a complex sulfide phase 72 dispersed in the matrix 71 and containing not less than 40 atom % and not more than 75 atom % Mn, not less than 3 atom % and not more than 30 atom % Fe, and not less than 1 atom % and not more than 55 atom % S. The complex sulfide phase 72 may contain Cu. In the present embodiment, the matrix 71 has a single phase of a phase. The proportion of the complex sulfide phase 72 in the copper alloy for sliding members is not less than 3 vol % and not more than 20 vol %. The composition of the sulfides constituting the complex sulfide phase 72 can be confirmed, for example, by energy dispersive spectroscopy (EDS). The proportion of the complex sulfide phase 72 in the copper alloy for sliding members can be measured, for example, by image analysis using a digital microscope.

The copper alloy for sliding members constituting the sliding layer 29 is a copper alloy having excellent wear resistance while avoiding the addition of Pb, by having, in the Cu alloy with the appropriate component composition described above, a structure in which the Mn—Fe based complex sulfide phase 72 having a certain atomic ratio is dispersed in the matrix 71 made of bronze. The bushing 20 has a region including the inner wall 21A and the end surface 22A, which are the sliding surfaces, composed of the copper alloy for sliding members of the above embodiment. As a result, the bushing 20 is a sliding member whose sliding surface is composed of a copper alloy for sliding members having excellent wear resistance while avoiding the addition of Pb.

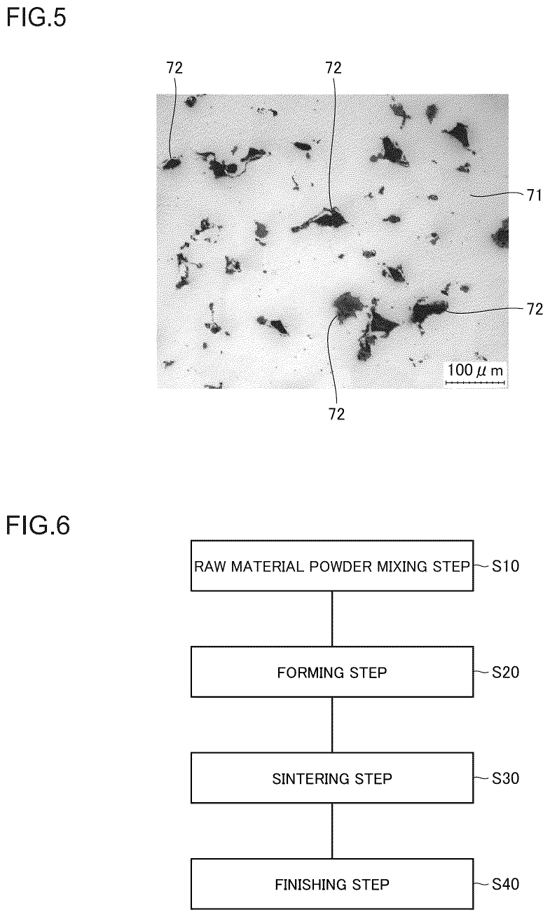

An example of a method of producing a copper alloy for sliding members of the present embodiment will now be described. FIG. 6 is a flowchart illustrating the outline of the method of producing a copper alloy for sliding members. Referring to FIG. 6, in the method of producing a copper alloy for sliding members of the present embodiment, a raw material powder mixing step is first performed as step S10. In this step S10, for example, (1) pure Cu powder, (2) Cu alloy powder containing 10 mass % to 40 mass % Sn, (3) at least one of FeS powder and CuS powder, and (4) at least one selected from the group consisting of Cu alloy powder containing not less than 5 mass % Mn, Fe—Mn alloy powder containing not less than 60 mass % Mn, and Mn powder, are mixed so as to fulfill the component composition of the copper alloy for sliding members of the present embodiment described above.

Next, a forming step is performed as step S20. In this step, the mixed powder mixed and obtained in step S10 is compacted by using, for example, a press machine having a die with a cavity of a desired shape. Specifically, the mixed powder is filled into the cavity and compacted by using the press machine, to thereby obtain a formed body. In the case of producing a copper alloy for sliding members joined to a steel plate, the formed body is placed on the steel plate. Alternatively, for example, the mixed powder may be spread on a flat steel plate to have a uniform thickness.

Next, a sintering step is performed as step S30. In this step S30, the formed body obtained in step S20 is sintered using a sintering furnace. For example, while a reducing atmosphere is supplied to the sintering furnace, the formed body is heated to a temperature range of not lower than 800° C. and not higher than 1000° C. and held for a predetermined period of time. At this time, a liquid phase generated by sintering accelerates the reaction, and a Mn—Fe based complex sulfide phase is formed in a matrix made of bronze. The formed body placed on the steel plate in step S20 is joined to the steel plate at the same time as being sintered. The mixed powder spread on the steel plate to have a uniform thickness in step S20 is sintered into a sintered body and also joined to the steel plate. If the obtained sintered body has an insufficient density, rolling may be performed using a rolling mill. To further increase the density, the above-described sintering and rolling may be repeated a plurality of times, for example, twice.

Next, a finishing step is performed as step S40. Although this is not an essential step, it can be performed as required. For example, grinding, polishing, or other processing as well as sealing can be performed on the surface of the copper alloy for sliding members as the sintered body. Furthermore, to form a bushing 20 using a copper alloy coated steel plate in which a layer of the copper alloy for sliding members as the sintered body is formed on the steel plate, the following procedure can be adopted. Firstly, the copper alloy coated steel plate is cut into a strip. Then, the strip is roundly bent into a cylindrical shape by using a press machine such that the layer of the copper alloy for sliding members becomes an inner wall, thereby fabricating the main body 21. In addition, the copper alloy coated steel plate is machined into a disk shape, thereby fabricating the flange 22. Then, the two are joined together by friction welding in such a manner that the side of the flange 22 on which the layer of the copper alloy for sliding members has been formed is opposite to the main body 21, to thereby obtain the bushing 20.

According to the above-described procedure, the copper alloy for sliding members and the bushing 20 as the sliding member of the present embodiment can be fabricated. While the above embodiment has described the case in which only a portion of the sliding member including the sliding surface is configured with the copper alloy for sliding members, the entire sliding member may be configured with the copper alloy for sliding members.

### EXAMPLES

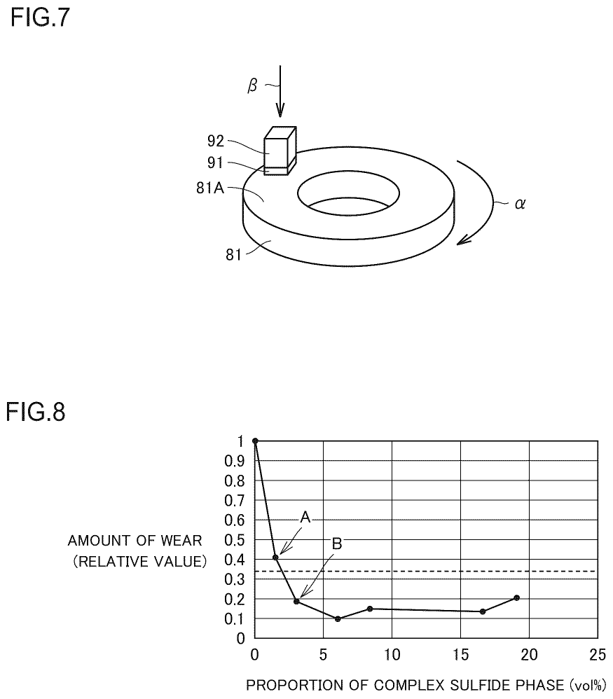

Copper alloys for sliding members of the present disclosure were fabricated and subjected to a test to confirm wear resistance. The experimental procedure was as follows. FIG. 7 is a schematic diagram illustrating a method of wear resistance test.

Referring to FIG. 7, samples having a sliding layer 91 composed of the copper alloy for sliding members of the present disclosure joined to a base body 92 were prepared by the same procedure as in the above embodiment. At this time, the volume proportion of the complex sulfide phase 72 was varied by changing, for example, the component composition of the copper alloy for sliding members constituting the sliding layer 91. For comparison, a sample having a sliding layer 91 that does not include the complex sulfide phase 72 was also fabricated. The component compositions of the samples are shown in Table 1.

TABLE 1

| | Component Composition | | | | | Proportion of Complex |
|---|---|---|---|---|---|---|
| | (mass %) | | | | | Sulfide Phase |
| | Cu | Sn | Fe | Mn | S | (vol %) |
| Sample 1 | 88 | 12 | 0 | 0 | 0 | 0 |
| Sample 2 | 86.5 | 12 | 0.3 | 0.4 | 0.3 | 1.5 |
| Sample 3 | 85.3 | 12 | 0.6 | 0.8 | 0.5 | 3.1 |
| Sample 4 | 83.3 | 12 | 1.2 | 1.6 | 1.0 | 6.1 |
| Sample 5 | 81.3 | 12 | 1.8 | 2.4 | 1.5 | 8.4 |
| Sample 6 | 75.7 | 12 | 3.7 | 4.7 | 3.0 | 16.6 |
| Sample 7 | 73.8 | 12 | 4.2 | 5.6 | 3.5 | 19.1 |

The samples thus obtained were each pressed against a surface 81A of a rotating disk 81 to measure the amount of wear of the sliding layer. The amount of wear was detected electrically by a sensor included in the test device and was recorded over time without removing the sample from the test device. The disk 81 adopted is made of JIS standard SUJ2 (bearing steel). The disk 81 has a flat, annular shape. The disk 81 was rotated circumferentially (in the direction along the arrow α) at a speed of 0.5 m/s. The sample was pressed in the direction along the arrow β so as to cause the sliding layer 91 to contact the surface (end surface) 81A of the disk 81. Lubricating oil heated to 80° C. was supplied to the contact portion between the sliding layer 91 and the disk 81 at a rate of 200 ml/min. The load of the pressing was increased such that the contact pressure between the sliding layer 91 and the disk 81 was increased stepwise. Specifically, the contact pressure was increased stepwise in the order of 0.9 MPa, 1.9 MPa, 3.0 MPa, 3.8 MPa, 4.8 MPa, 6.6 MPa, 8.6 MPa, 10.5 MPa, 14.3 MPa, 18.2 MPa, 28.8 MPa, 37.6 MPa, 47.3 MPa, and 57.0 MPa, with each pressure being maintained for ten minutes (140 minutes in total). The amount of wear at the end of the test was then obtained for each sample.

FIG. 8 is a diagram showing a relationship between the volume proportion of the complex sulfide phase and the wear resistance in each sample. In FIG. 8, the horizontal axis corresponds to the volume proportion of the complex sulfide phase. In FIG. 8, the vertical axis corresponds to the amount of wear. The amount of wear is shown as a relative value, with the amount of wear of the sample that does not include the complex sulfide phase taken as 1. The dashed line in FIG. 8 shows the amount of wear of a sample made of a conventional lead-containing copper alloy (lead bronze; JIS standard LBC2 (CAC602)) in the case where the sample was used to perform the same wear resistance test.

Referring to FIG. 8, the sample with the proportion of the complex sulfide phase of 1.5 vol % has the amount of wear (data point A in FIG. 8) significantly reduced from that of the sample including no sulfides, and has a wear resistance comparable to that of the lead bronze as the conventional material. Furthermore, the sample with the proportion of the complex sulfide phase of 3 vol % or more (3.1 vol %) has the amount of wear (data point B in FIG. 8) smaller than that of the lead bronze as the conventional material, so it can be said that the sample has excellent wear resistance. This state of small wear amount is maintained at least in the range where the proportion of the complex sulfide phase is 20 vol % or less (more specifically, 19.1 vol % or less). The above experimental results confirm that the copper alloy for sliding members of the present disclosure is capable of providing a copper alloy for sliding members having excellent wear resistance while avoiding the addition of Pb.

While the above embodiment has described the case in which the copper alloy for sliding members of the present disclosure is applied to a bushing included in a track travel device of a work machine, the use of the copper alloy for sliding members of the present disclosure is not limited thereto; it is applicable to a variety of uses in which sliding properties and wear resistance are required. For example, the copper alloy for sliding members of the present disclosure can be used as a material for components of hydraulic equipment, such as cylinder blocks, piston shoes, cradles, and valve plates used in hydraulic pumps, and side plates used in gear pumps.

It should be understood that the embodiments and examples disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

2: track; 3: track frame; 4: idler tumbler, 5: sprocket wheel; 6: track shoe; 7: outer link; 8: inner link; 9: track link; 10: track roller, 11: carrier roller, 20: bushing; 21: main body; 21A: inner wall; 22: flange; 22A: end surface; 23: through hole; 28: base portion; 29: sliding layer; 51: sprocket tooth; 71: matrix; 72: complex sulfide phase; 81: disk; 81A: surface; 91: sliding layer, 92: base body; 100: hydraulic excavator, 101: track travel device; 101A: track; 103: revolving unit; 104: work implement; 105: boom; 106: arm; 107: bucket; and 108: cab.

1. A copper alloy for sliding members, having a component composition containing
not less than 0.4 mass % and not more than 6 mass % Mn,
not less than 0.3 mass % and not more than 5 mass % Fe,
not less than 0.3 mass % and not more than 3.5 mass % S, and
not less than 1 mass % and not more than 15 mass % Sn, with the balance being Cu and unavoidable impurities,
the copper alloy having a structure including
a matrix made of bronze, and
a complex sulfide phase dispersed in the matrix, the complex sulfide phase containing not less than 40 atom % and not more than 75 atom % Mn, not less than 3 atom % and not more than 30 atom % Fe, and not less than 1 atom % and not more than 55 atom % S.

2. The copper alloy for sliding members according to claim 1, wherein the bronze constituting the matrix has a single phase of α phase.

3. The copper alloy for sliding members according to claim 1, wherein a proportion of the complex sulfide phase in the copper alloy for sliding members is not less than 3 vol % and not more than 20 vol %.

4. A sliding member including a sliding surface which comes into contact with and slides against another member,
the sliding member having at least a region including the sliding surface composed of the copper alloy for sliding members according to claim 1.

5. A method of producing a copper alloy for sliding members, comprising the steps of:
preparing mixed powder by mixing Cu powder, Cu alloy powder containing not less than 10 mass % and not more than 40 mass % Sn, at least one of FeS powder and CuS powder, and at least one selected from the group consisting of Cu alloy powder containing not less than 5 mass % Mn, Fe—Mn alloy powder containing not less than 60 mass % Mn, and Mn powder, so as to achieve a component composition containing not less than 0.4 mass % and not more than 6 mass % Mn, not less than 0.3 mass % and not more than 5 mass % Fe, not less than 0.3 mass % and not more than 3.5 mass % S, and not less than 1 mass % and not more than 15 mass % Sn, with the balance being Cu and unavoidable impurities;
fabricating a formed body by compacting the mixed powder; and
forming, by heating the formed body, a structure including a matrix made of bronze and a complex sulfide phase dispersed in the matrix, the complex sulfide phase containing not less than 40 atom % and not more than 75 atom % Mn, not less than 3 atom % and not more than 30 atom % Fe, and not less than 1 atom % and not more than 55 atom % S.
